(19) United States
(12) Patent Application Publication
(10) Pub. No.: US 2025/0164666 A1
(43) Pub. Date: May 22, 2025

(54) COMPOSITION FOR CAMERA MODULE LENS AND CAMERA MODULE LENS COMPRISING THE SAME

(71) Applicant: Samsung Electro-Mechanics Co., Ltd., Suwon-si (KR)

(72) Inventors: Min Ji KIM, Suwon-si (KR); Sang Hyun KWON, Suwon-si (KR); Su Min KANG, Suwon-si (KR)

(73) Assignee: Samsung Electro-Mechanics Co., Ltd., Suwon-si (KR)

(21) Appl. No.: 18/769,569

(22) Filed: Jul. 11, 2024

(30) Foreign Application Priority Data
Nov. 9, 2023 (KR) 10-2023-0154796
Dec. 29, 2023 (KR) 10-2023-0197296

(51) Int. Cl. G02B 1/04; C08K 5/3475; C08L 23/02; C08L 69/00

(52) U.S. Cl. CPC G02B 1/041; C08K 5/3475; C08L 23/025; C08L 69/00; C08L 2201/10

(57) ABSTRACT

A composition for a camera module lens and a camera module lens including the composition are provided, the composition for a camera module lens includes a resin; and 0.01 to 0.1% by weight of a benzotriazole-based ultraviolet (UV) blocking additive with respect to a total weight of the composition, wherein when the composition for a camera module lens is applied to the lens, light with a visible light region may be transmitted without performing separate coating and light within a UV region may be cut-off.

### CROSS-REFERENCE TO RELATED APPLICATIONS

This application claims the benefit under 35 USC § 119 (a) of Korean Patent Application Nos. 10-2023-0154796, filed on Nov. 9, 2023, and 10-2023-0197296, filed on Dec. 29, 2023, in the Korean Intellectual Property Office, the entire disclosures of which are incorporated herein by reference for all purposes.

### BACKGROUND

### 1. Field

The following description relates to a camera module lens composition, and a camera module lens including the same.

### 2. Description of Related Art

An automotive camera installed in a car includes a viewing camera, which captures images of the driver's surroundings, and a sensing camera, which senses the vehicle's surroundings.

Recently, with the advancement of autonomous driving, the number of camera pixels has increased, and the development and marketability sensing cameras, a high value-added product, has expanded.

Additionally, a camera module lens attached to the exterior of the vehicle may be easily exposed to various external contaminants and changes in temperature and humidity, resulting in great difficulty in continuously acquiring clear images.

To prevent this, a technology was developed so that the outermost layer of the camera module lens is coated with a water-repellent coating layer to have its own cleaning power and to prevent fogging.

However, in the case of most commercially available water-repellent coating layers, there is a problem that a coating lifespan may be shortened due to continuous ultraviolet (UV) irradiation due to exposure to sunlight, and an internal lens may also be deteriorated by UV irradiation.

In particular, an automotive camera module lens may be formed of plastic. In order to block UV rays, a surface of the plastic lens may be repeatedly coated with silicon dioxide (SiO₂) and titanium dioxide (TiO₂) materials in nm units using a Physical Vapor Deposition (PVD) method to form an anti-reflection (AR) coating film. UV blocking is performed by this AR coating film.

In this example, AR coating may be performed by forming a liquid film of water or an aqueous solution on a surface of a cured film of a plastic lens containing an organosilicon compound and contacting the same with ozone gas to deposit the same on the surface.

However, in the method of blocking UV by forming the AR coating film, an additional coating process may be necessary, and the method may have cause defects such as peeling, cracking, or the like, during reliability testing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a composition for a camera module lens includes a resin; and 0.01 to 0.1% by weight of a benzotriazole-based ultraviolet (UV) blocking additive with respect to a total weight of the composition.

The UV blocking

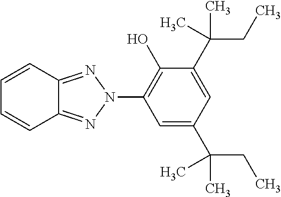 [SMILES: CCC(C)(C)c1cc(-n2nc3ccccc3n2)c(O)c(C(C)(C)CC)c1]

additive has a chemical structure of Formula 1:

Unit molecules of the UV blocking additive may be adsorbed or dispersed between polymer chains of the resin.

The UV blocking additive may have a chemical structure of the following Formula:

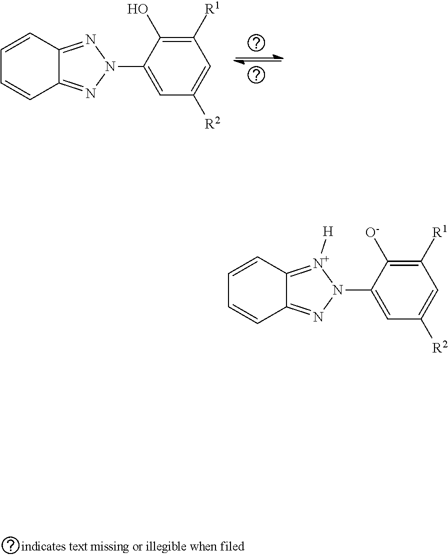

The UV blocking additive may be one in which R1 and R2 are substituted with at least one of hydrogen, methyl, ethyl, and propyl, where R1 is a first methyl group and R2 is a second methyl group.

The resin may be formed of one of a polycarbonate (PC)-based resin and a polyolefine-based resin.

The polyolefin-based resin may be one of a cyclo-olefin co-polymer (COC)-based resin and a cyclo-olefin polymer (COP)-based resin.

A camera module lens may include the composition for a camera module lens.

The camera module lens may be manufactured by compounding the resin and the UV blocking additive.

The camera module lens may be disposed in an automotive camera module.

In a general aspect, a camera module includes a plurality of lenses including a resin, and a benzotriazole-based ultraviolet (UV) blocking additive that reduces UV blocking transmittance to 20% in a UV cut-off region of 400 nm.

The benzotriazole-based UV blocking additive may be included in an amount of 0.01 to 0.1% by weight based on a total weight of the lenses.

Other features and aspects will be apparent from the following detailed description, the drawings, and the claims.

### BRIEF DESCRIPTION OF DRAWINGS

FIG. 1 is a cross-sectional view schematically illustrating an example camera module to which a lens is applied, in accordance with one or more embodiments.

FIG. 2 illustrates an enlarged view of portion A of the lens of FIG. 1.

FIG. 3 is a graph illustrating light transmittance of a lens formed only of a typical PC resin.

FIG. 4 is a graph illustrating light transmittance of an example lens formed of a first composition, in accordance with one or more embodiments.

FIGS. 5 and 6 are graphs illustrating light transmittance of an example lens formed of a second composition, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a composition for a camera module lens that can effectively block UV by cutting off light within a UV region, and may not make it necessary to provide a separate coating film when applied to the lens, thereby preventing defects such as peeling, cracking, or the like, caused by typical AR coating, and a camera module lens including the same.

### A. Composition for Camera Module Lens

A composition for a camera module lens, in accordance with one or more embodiments, may include a resin and an ultraviolet (UV) blocking additive.

In this example, the mixing of the resin and the UV blocking additive may be performed through compounding.

Additionally, as illustrated in FIG. 2, unit molecules 20 of the UV blocking additive may be adsorbed or dispersed between polymer chains 10 of the resin.

The resin may be an optical resin, and may be formed of a polycarbonate (PC)-based resin or a polyolefine-based resin, as only examples.

The polyolefin-based resin may be one of a cyclo-olefin co-polymer (COC)-based resin and a cyclo-olefin polymer (COP)-based resin.

The UV blocking additive may prevent photo-oxidation of a plastic lens, and is a benzotriazole-based UV blocking additive.

The benzotriazole-based UV blocking additive may have better miscibility with the polycarbonate or polyolefin-based resins, which are main components of the composition for a camera module lens, than other UV blocking additives, so no residue is left when compounding, and internal foreign matter defects may be effectively prevented during lens injection, and making it easy to target concentration and transmittance of the lens.

The benzotriazole-based UV blocking additive, in accordance with one or more embodiments, may have a chemical structure of Formula 1 below.

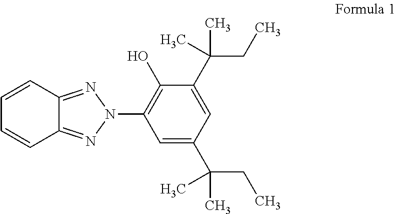 [SMILES: CCC(C)(C)c1cc(-n2nc3ccccc3n2)c(O)c(C(C)(C)CC)c1]

In this example, the UV blocking additive may be included in an amount of 0.01 to 0.1% by weight based on a total weight of the composition.

When a content of the UV blocking additive is less than 0.01% by weight, the UV blocking effect may be significantly reduced, and problems due to exposure to sunlight may occur in a lens manufactured with this composition.

Additionally, when the content of the UV blocking additive exceeds 0.1% by weight, not only does the UV blocking effect not increase significantly, but when unit molecules of the additive are mixed, residues are generated as the unit molecules are saturated in the composition, and the residues may actually reduce transmittance with a visible light region, which is an effective wavelength region of the manufactured lens, which may cause problems such that the performance of the lens may deteriorate or the lens may become unusable.

The UV blocking additive, in accordance with one or more embodiments, may have a chemical structure of Formula 2 below.

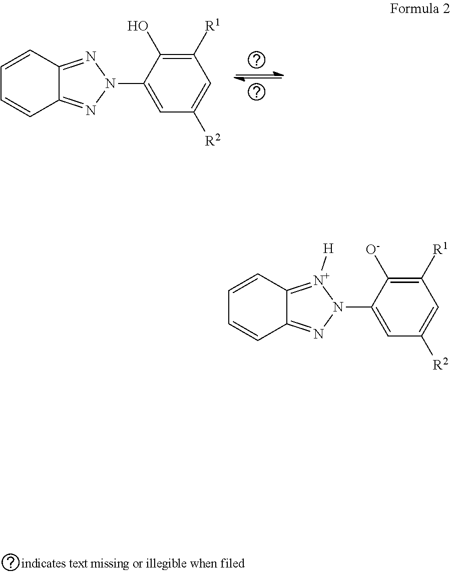

In this example, R1 and R2 may be substituted with at least one of the following functional groups such as hydrogen, methyl, ethyl, and propyl.

### Structure of Functional Groups:

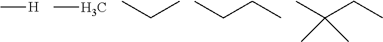

The UV blocking additive having the chemical structure of Formula 2 above may have better complementarity with a resin material, which is a main component of the lens, and may have higher miscibility with the resin, as compared to the lens using the UV blocking additive having the chemical structure of Formula 1 above, so that the UV blocking additive may be injected into the lens more easily.

Accordingly, a phenomenon in which a decrease in UV blocking performance which occurs during compounding after mixing the resin and UV blocking additive, may be suppressed or prevented more effectively, as compared to the UV blocking additive having the chemical structure of Formula 1, so that a lens having excellent UV blocking effects may be provided.

As described above, when a benzotriazole-based UV blocking additive is applied and the benzotriazole-based UV blocking additive is applied to the lens, the composition for the camera module lens, in accordance with one or more embodiments, may provide a lens that may prevent defects such as peeling, cracking, or the like, caused by typical AR coating while having excellent optical properties by transmitting light within a visible light region without performing separate coating and cutting off light within a UV region.

### B. Camera Module Lens

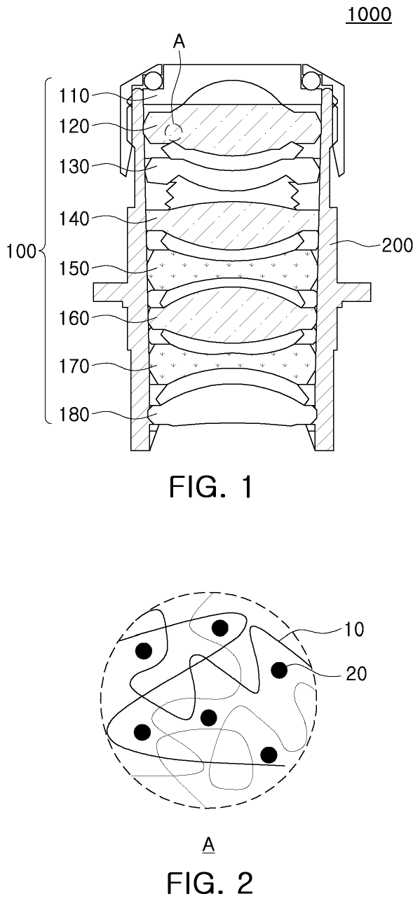

As illustrated in FIG. 1, an example camera module 1000, to which an example lens of the one or more embodiments is applied, includes a plurality of lenses 100 and a lens barrel 200 in which an accommodation space that accommodates the plurality of lenses 100 is formed.

Among the lenses 100, reference numerals 110, 130, and 180 are lenses formed of glass.

Among the lenses 100, reference numerals 120, 140, 150, 160, and 170 are plastic lenses, and these plastic lenses include a resin and a UV blocking additive. In this example, the UV blocking additive is a benzotriazole-based UV blocking additive and is included in an amount of 0.01 to 0.1% by weight based on a total weight of the lens.

These lenses (the plastic lenses) 120, 140, 150, 160, and 170 may cut off the UV region even without performing separate coating such as AR coating, and may be manufactured by compounding a composition manufactured by adding a specific UV blocking additive to an optical resin rather than surface coating or deposition.

When UV weather resistance reliability of automotive cameras is performed, an internal plastic lens of the lens assembly may be decomposed due to a photo-oxidation reaction of the polymer chain due to strong UV rays.

Therefore, typically, in order to protect the internal lens from UV rays, UV rays reaching the internal plastic lens are blocked through AR coating or water-repellent coating on the lens.

However, in the example of AR coating, a coefficient of thermal expansion is different when coating is performed on a plastic material, so there is a high possibility of cracks and microcracks occurring due to repeated contraction and expansion, and when a coating crack occurs, it is impossible to prevent ultraviolet rays from penetrating into the lenses located thereinside, which may cause a change in the appearance of the material (discoloration, microcracks, and the like).

The example camera module lens, in accordance with one or more embodiments, may secure excellent transmittance characteristics and have excellent high temperature stability by mixing a benzotriazole-based UV blocking additive with the resin and injecting the same in the form of a lens, and may have excellent optical properties by transmitting light within a visible light region and cutting off light within a UV region.

The example camera module lens configured as above may be applied to product lines such as, but not limited to, smartphones and AR/VR, and may be especially applied to automotive camera module lenses. However, the examples are not limited thereto.

### C. Experimental Example

Hereinafter, the in accordance with one or more embodiments will be described in more detail through experimental examples. However, this is intended to aid specific understanding of the one or more embodiments, and the scope of the one or more embodiments is not limited by the experimental examples.

In this example, the components of the resin and dye in the lens may be confirmed through mass using Thermogravimetric analysis combined with gas chromatography/mass spectrometry (TGA-GC/MS).

By the above-described method, an approximate concentration of the components in the lens may be confirmed, and since a molar extinction coefficient may be different for each material, UV-VIS analysis is further performed to confirm the exact concentration.

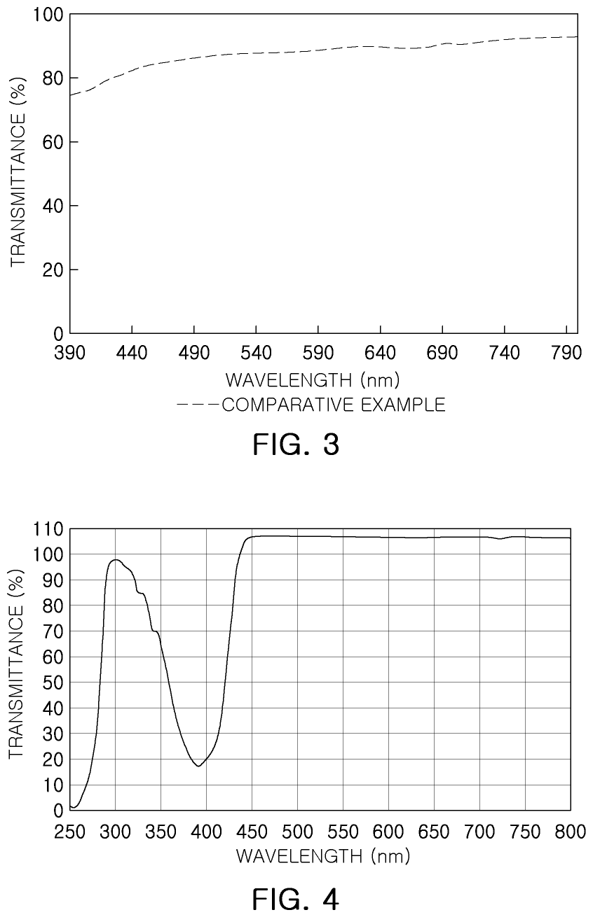

FIG. 3 is a graph illustrating light transmittance of a composition not including a UV blocking additive, and FIG. 4 is a graph illustrating light transmittance of a composition according to a first embodiment.

In this example, the sample of FIG. 4 has a resin polycarbonate (PC), and includes by weight, 0.1% by weight of a benzotrizole-based first UV blocking additive based on a total weight of the sample, and the first UV blocking additive has R1 and R2 having methyl groups. In an example, R1 may be a first methyl group and R2 may be a second methyl group.

Referring to FIG. 3, it can be seen that there is no UV blocking effect in the comparative example.

On the other hand, as illustrated in FIG. 4, when 0.1% by weight of the first benzotriazole-based UV blocking additive is included in the PC resin, it can be confirmed that UV blocking transmittance is 20% in a UV region of 400 nm, which is a UV cut-off region.

Therefore, when the composition, in accordance with one or more embodiments, is applied to a lens, most of the UV is absorbed without reducing the transmittance of visible light, thereby preventing photo-oxidation of the lens itself, and in addition, a camera module lens that can also prevent UV photo-oxidation of internal lenses in a direction from the camera module 1000 to the sensor may be provided.

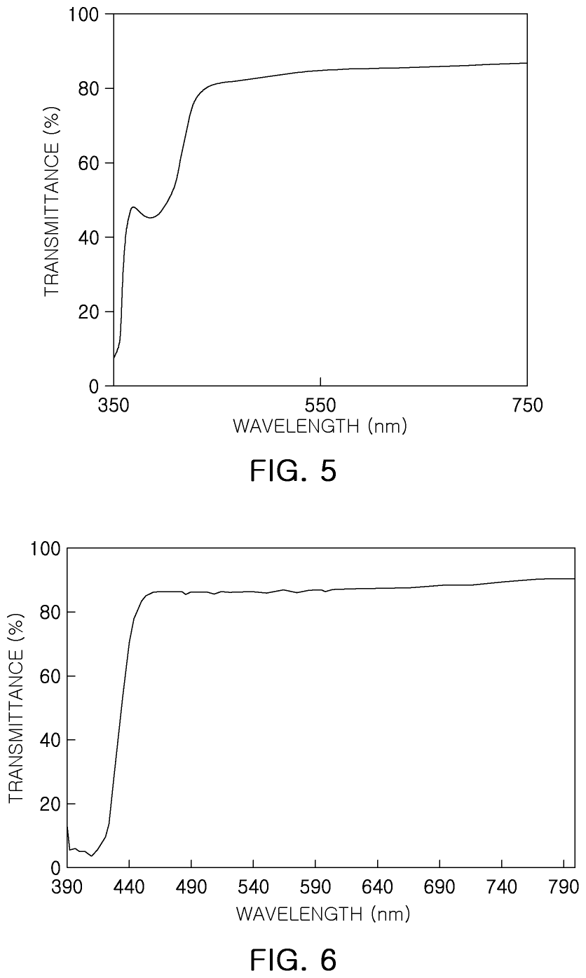

FIGS. 5 and 6 are graphs illustrating light transmittance of a composition, according to a second embodiment.

In the sample of FIG. 5, a resin is PC, 0.01% by weight of a second UV blocking additive of a benzotriazole-based second UV blocking additive having the chemical structure of Formula 2 is included based on the total weight of the composition, and in the sample of FIG. 6, a resin is PC, and 0.1% by weight of a second UV blocking additive of a benzotriazole-based second UV blocking additive having the chemical structure of Formula 2 is included based on the total weight of the composition.

As illustrated in FIG. 5, when 0.01% of the benzotriazole-based second UV blocking additive is included in the PC resin, UV blocking transmittance is 46% in a region having a wavelength of 400 nm, which a UV region, confirming that UV is cut-off.

Additionally, even though 1/10 of the UV blocking additive compared to the results in FIG. 4, the UV blocking transmittance only increased by about 2 times, confirming that the second UV blocking additive has a superior UV blocking effect compared to the first UV blocking additive.

As illustrated in FIG. 6, when 0.1% by weight of the first benzotriazole-based UV blocking additive is included in the PC resin, the UV blocking transmittance is 5% in a region having a wavelength of 400 nm, which is a UV region, confirming that UV is cut-off. Additionally, it can be seen that the content of UV blocking additives and the UV blocking effect are proportional.

Additionally, compared to the results in FIG. 4, the UV blocking additive was used at the same level, but the UV blocking transmittance was reduced by about 4 times, so it can be seen that the second UV blocking additive has a superior UV blocking effect compared to the first UV blocking additive.

As set forth above, in accordance with one or more embodiments, a composition for a camera module lens may have excellent optical properties and may prevent defects such as peeling, cracking, or the like, caused by typical AR coating by transmitting light within a visible light region without performing separate coating, and cutting off light within a UV region.

The composition for an example camera module lens may be used in a camera module lens for automotive products, or the like, as non-limited examples.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A composition for a camera module lens, the composition comprising:
a resin; and
0.01 to 0.1% by weight of a benzotriazole-based ultraviolet (UV) blocking additive with respect to a total weight of the composition.

2. The composition of claim 1, wherein the UV blocking additive has a chemical structure of Formula 1 below:

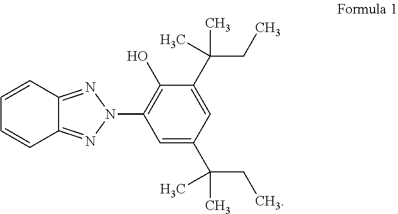 [SMILES: CCC(C)(C)c1cc(-n2nc3ccccc3n2)c(O)c(C(C)(C)CC)c1]

3. The composition of claim 1, wherein unit molecules of the UV blocking additive are adsorbed or dispersed between polymer chains of the resin.

4. The composition of claim 1, wherein the UV blocking additive has a chemical structure of the following Formula:

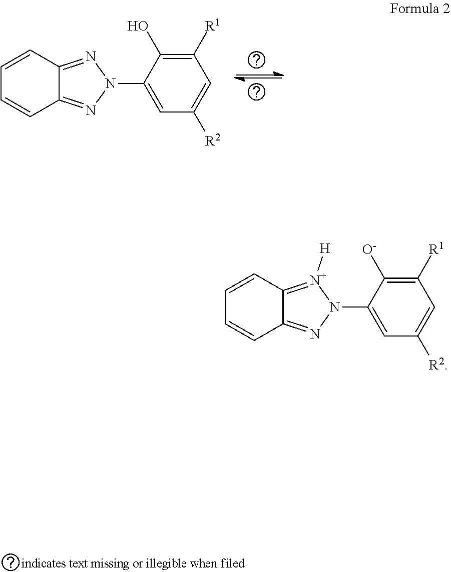

5. The composition of claim 4, wherein the UV blocking additive is one in which R1 and R2 are substituted with at least one of hydrogen, methyl, ethyl, and propyl, where R1 is a first methyl group and R2 is a second methyl group.

6. The composition of claim 1, wherein the resin is formed of one of a polycarbonate (PC)-based resin and a polyolefine-based resin.

7. The composition of claim 6, wherein the polyolefin-based resin is one of a cyclo-olefin co-polymer (COC)-based resin and a cyclo-olefin polymer (COP)-based resin.

8. A camera module lens comprising the composition for a camera module lens of claim 1.

9. The camera module lens of claim 8, wherein the camera module lens is manufactured by compounding the resin and the UV blocking additive.

10. The camera module lens of claim 8, wherein the camera module lens is disposed in an automotive camera module.

11. A camera module, comprising:
a plurality of lenses comprising:
a resin, and
a benzotriazole-based ultraviolet (UV) blocking additive that reduces UV blocking transmittance to 20% in a UV cut-off region of 400 nm.

12. The camera module of claim 11, wherein the benzotriazole-based UV blocking additive is included in an amount of 0.01 to 0.1% by weight based on a total weight of the lenses.
